(19) United States
(12) Patent Application Publication
(10) Pub. No.: US 2025/0129705 A1
(43) Pub. Date: Apr. 24, 2025

(54) REAL-TIME WEAR DETECTION AND LIFECYCLE PREDICTION FOR WELL FACILITIES

(71) Applicant: HALLIBURTON ENERGY SERVICES, INC., Houston, TX (US)

(72) Inventors: Christina Marie Harrington, Tulsa, OK (US); Ketankumar Kantilal Sheth, Tulsa, OK (US); Benjamin David Hoekstra, Denver, CO (US); Gerald Glen Goshorn, Tulsa, OK (US); Bobby Neal Armstrong, Tulsa, OK (US)

(73) Assignee: HALLIBURTON ENERGY SERVICES, INC., Houston, TX (US)

(21) Appl. No.: 18/492,467

(22) Filed: Oct. 23, 2023

(51) Int. Cl. E21B 47/008; G06N 20/00

(52) U.S. Cl. CPC E21B 47/008; G06N 20/00

(57) ABSTRACT

Disclosed are systems, apparatuses, methods, and computer readable medium for extracting materials from a well and real-time wear detection and lifecycle prediction for well facilities. A method includes: receiving first measurement data associated with or from a first equipment submersed into a downhole environment during a portion of a current operation for extracting materials from the downhole environment at a pumping system; and estimating a wear rate associated with the first equipment based on an operational assessment of the downhole environment.

### TECHNICAL FIELD

The present technology pertains to a system for extracting materials from a well and real-time wear detection and lifecycle prediction for well facilities.

### BACKGROUND

A well system comprises a well-drilling system to form the well and a well-pumping system to retrieve materials from the well. A well-drilling system is a setup of equipment and machinery designed to extract natural resources, such as water, oil, or gas, from the ground. The system typically includes a drilling rig, which is used to bore a hole into the earth's crust, and a casing, which is a steel pipe that lines the well and prevents the walls from collapsing. The drilling process begins with the placement of a drill bit at the end of a drill string. The drill bit is then rotated, using a motor or a manual mechanism, to create a hole in the ground. As the hole is drilled, the drill string is gradually lengthened by adding more sections of pipe. The process continues until the desired depth is reached.

Once the drilling is complete, a casing is installed into the well to protect it from collapse and prevent contamination of the extracted resources. The casing is typically cemented into place to seal off any potential pathways for groundwater to enter the well. Once the well is prepared, a well-pumping system is installed to extract the resources from the well. The type of pump used depends on the type of resource being extracted, as well as the depth and diameter of the well. For example, a submersible pump, a sub pump, or a reciprocating pump may be used for an oil well.

### BRIEF DESCRIPTION OF THE DRAWINGS

In order to describe the manner in which the various advantages and features of the disclosure may be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a schematic diagram of an example logging while drilling (LWD) wellbore operating environment in accordance with various aspects of the disclosure;

FIG. 1B is a diagram of an example downhole environment having tubulars, in accordance with various aspects of the disclosure;

FIG. 2 illustrates an example of a performance curve of a well pumping system in accordance with some aspects of the disclosure;

FIG. 3 illustrates a block diagram of an extraction monitoring system configured to monitor correction of equipment within a downhole environment in real-time in accordance with some aspects of the disclosure;

FIG. 4 is a conceptual diagram of a training system of a wear model for estimating wear rates of at least one equipment disposed within a harsh environment in accordance with some aspects of the disclosure;

FIG. 5 is a conceptual diagram of a prediction system for estimating wear rates of at least one equipment disposed within a harsh environment in accordance with some aspects of the disclosure;

FIG. 6 is an example of a user interface associated with an application for monitoring and/or controlling operations of a well pumping system in accordance with some aspects of the disclosure;

FIG. 7 illustrates an example method for detecting wear rate in connection with operating a well pumping system in accordance with some aspects of the disclosure; and

FIG. 8 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously described, a well system (or a well site) includes a large number of interoperating components, and many of these components experience wear and tear, failure, adverse conditions, and other general issues that may affect operation of the well site. In one illustrative aspect, an electric submersible pump (ESP) system, which is also referred to as an artificial lift pumping system, can be deployed into the downhole environment (e.g., into the well) and experiences high temperature, immense pressure, multi-phase viscous fluids, sand, fluid-borne abrasives, excessive gas, scale, and variable flow rate environments. Operators use a performance curve that is determined before the operation of a run, which is when equipment is inserted into the well and continues until the equipment is extracted from the well, ending the run. A run generally ends because of failure of the equipment that prohibits further extraction of production fluid and associated materials. Equipment within a downhole environment is subject to harsh conditions due to temperature, pressure, fluid properties and associated material (gas, sand, well debris, etc.), and extraction operations and will mechanically fail for various reasons.

In the event that a run ends, material is unable to be extracted from the well, and a delay in further extracting materials is incurred because of equipment rehabilitation. The start and end of a run are also dictated by additional and/or new equipment and personnel required to extract the submersed equipment and insert the submersed equipment. The end of a run to replace downhole equipment is a disruptive event that leads to less optimal usage of resources, scheduling conflicts, and other challenges within the extraction facilities.

The disclosed technology addresses the foregoing by using measurement information and machine learning (ML) models to predict wear rates of equipment within downhole environments. For example, based on current operating parameters, such as the amount of power applied to downhole equipment, pump intake pressure, pump frequency (e.g., cycles per second (Hz)) or operating speed in revolutions per minute (RPM) or cycles per second (Hz), and other information, the ML models can infer the wear rates of the equipment within the downhole environment that is unable to be objectively or statistically performed by a person in real-time. For example, some pumps operate from 1800 to 5400 rpm (e.g., 30 Hz to 90 Hz). However, other pumps can operate up to 10,000 rpm and may have other different mechanical and electrical characteristics that affect a pump's lifecycle. A statistics engine can be used to determine statistical information of the lifecycle of the well pumping system and provide feedback information. An operation of the well pumping system may use the statistical information to control the equipment within the well pumping system for optimal production of material and scheduling of resources related to other field operations.

Additional details and aspects of the present disclosure are described in more detail below with respect to the figures.

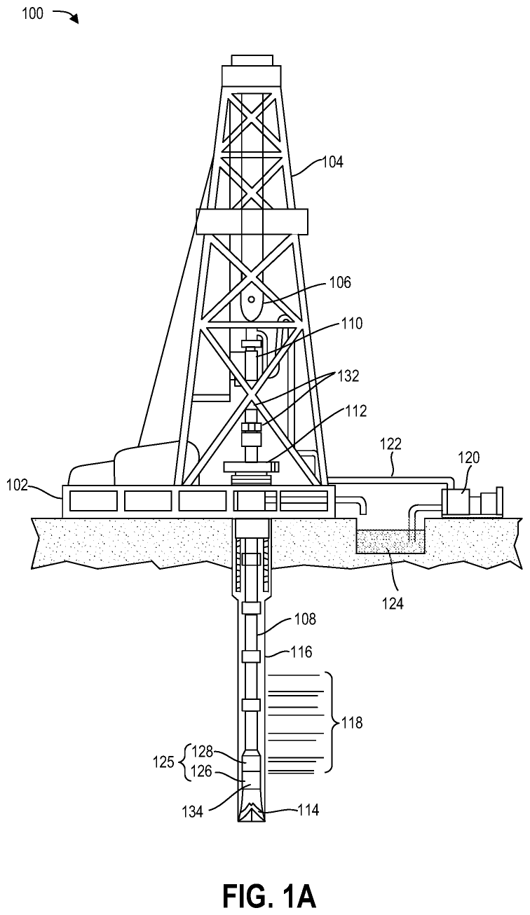

FIG. 1A is a schematic diagram of an example logging while drilling (LWD) operating environment of a well site, in accordance with various aspects of the disclosure.

In some aspects, a drilling arrangement is shown that exemplifies a LWD configuration in a wellbore drilling scenario 100. The LWD typically incorporates sensors that acquire formation data. The drilling arrangement of FIG. 1A also exemplifies measurement while drilling (MWD) and utilizes sensors to acquire data from which the wellbore's path and position in three-dimensional space may be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 may be connected to the lower end of the drill string 108. As the drill bit 114 rotates, the drill bit 114 creates a wellbore 116 that passes through one or more subterranean formations 118. A pump 120 circulates drilling fluid through a supply pipe 122 to top drive 110, down through the interior of the drill string 108, and out orifices in the drill bit 114 into the wellbore. The drilling fluid returns to the surface via the annulus around the drill string 108, and into a retention pit 124. The drilling fluid transports cuttings from the wellbore 116 into the retention pit 124 and the drilling fluid's presence in the annulus aids in maintaining the integrity of the wellbore 116. Various materials may be used for drilling fluid, including oil-based fluids and water-based fluids.

In some aspects, one or more logging tools 126 may be integrated into the bottom-hole assembly 125 near the drill bit 114. As the drill bit 114 extends the wellbore 116 through the subterranean formations 118, logging tools 126 collect measurements relating to various formation properties as well as the orientation of the tool and various other drilling conditions. In some cases, the logging tools interface with various sensors and equipment. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or another communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

In at least some instances, one or more of the logging tools 126 may communicate with a surface receiver 132 by a wire, such as a wired drill pipe. In other cases, the one or more of the logging tools 126 may communicate with a surface receiver 132 by wireless signal transmission, such as ground penetrating radar. In at least some cases, one or more of the logging tools 126 may receive electrical power from a wire that extends to the surface, including wires extending through a wired drill pipe.

In some aspects, a collar 134 is a frequent component of a drill string 108 and generally resembles a very thick-walled cylindrical pipe, typically with threaded ends and a hollow core for the conveyance of drilling fluid. In some cases, multiple collars 134 may be included in the drill string 108 and are constructed and intended to be heavy to apply weight on the drill bit 114 to assist the drilling process. Because of the thickness of the collar's wall, pocket-type cutouts or other type recesses may be provided into the collar's wall without negatively impacting the integrity (strength, rigidity, and the like) of the collar 134 as a component of the drill string 108.

FIG. 1B is a diagram of an example downhole environment having tubulars in accordance with various aspects of the disclosure. In some aspects, an example system 140 is depicted for conducting downhole measurements after at least a portion of a wellbore has been drilled and the drill string removed from the well. A downhole tool is shown having a tool body 146 to perform logging, measurements, and/or other operations. For example, instead of using the drill string 108 of FIG. 1A to lower a tool body 146, which may contain sensors and/or other instrumentation for detecting and logging nearby characteristics and conditions of the wellbore 116 and surrounding formations, a wireline conveyance 144 may be used.

The tool body 146 may be lowered into the wellbore 116 by wireline conveyance 144. The wireline conveyance 144 may be anchored in the drill rig 142 or by a portable device such as a truck 145. The wireline conveyance 144 may include one or more wires, slicklines, cables, and/or the like, as well as tubular conveyances such as coiled tubing, joint tubing, or other tubulars.

The wireline conveyance 144 provides power and support for the tool, as well as enabling communication between processing systems 148 on the surface. In some examples, the wireline conveyance 144 may include electrical and/or fiber optic cabling for performing any communications. The wireline conveyance 144 is sufficiently strong and flexible to tether the tool body 146 through the wellbore 116, while also permitting communication through the wireline conveyance 144 to one or more of the processing systems 148, which may include local and/or remote processors. In some cases, power may be supplied via the wireline conveyance 144 to meet the power requirements of the tool. For slickline or coiled tubing configurations, power may be supplied downhole with a battery or via a downhole generator.

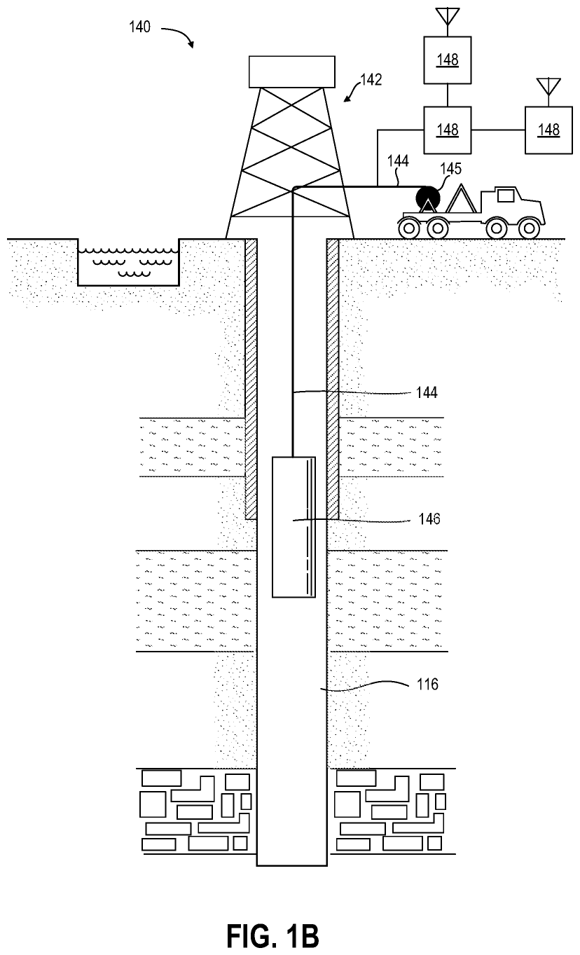

FIG. 2 illustrates an example of a performance curve 200 of a well pumping system in accordance with some aspects of the disclosure. The performance curve 200 is a static analysis of the equipment based on a standardized baseline evaluation as noted in American Petroleum Institute (API) recommended practice 11S2 (RP11S2). The performance curve 200 is an analysis of different parameters with respect to a flow rate (e.g., barrels per day, which is illustrated as barrels, e.g., 42 U.S. gallons). In this case, the flow rate is a volume per day. The performance curve 200 includes a head capacity 202, an efficiency 204, and a brake horsepower (BHP) 206. This performance curve is based on water having specific gravity of 1.00, operating at either 50 or 60 Hz for one stage. The pump is made of several stages ranging from 10 to 1000, depending upon the well conditions and pump setting depth in the well. In some aspects, the total head capacity is the vertical difference from the liquid level in the well to the surface plus the friction loss between the pump discharge and the well head pressure gauge. Generally, a single pump stage does not generate enough pressure and a pump may include several to several hundred stages. The pump is sometimes made of multiple sections as a pump section length is limited to 30 ft. The efficiency 204 is the measured power out divided by the power in. For example, for an ESP, the efficiency 204 corresponds to the head multiplied by the flow rate and divided by the BHP 206, and the flow rate is the volumetric rate of fluid delivered by the ESP. The BHP 206 is the power required by the ESP corrected for a fluid with a specific gravity of 1.0.

The head capacity 202, the efficiency 204, and the BHP 206 operate based on a flow rate. Manufacturers generally publish representative polynomial equations for head capacity 202 and BHP 206 with respect to performance on fresh water at a temperature of 60° F.

However, the head capacity 202, the efficiency 204, and the BHP 206 will be different in field environments. For example, the extracted material may be at a different temperature, viscosity of the fluid and associated material may be very different than water, multi-phase fluid (oil, gas, water and sand for example) having different density than water, variations in well conditions like fluid level changes, pressure variations, which affects the amount of power consumed by the pump.

The performance curve 200 includes a recommended operating region 208 that corresponds to an ideal operation for a well-pumping system. As head capacity increases, the efficiency drastically reduces and the recommended operating region 208 is the most efficient and reliable operation for maximizing material extraction.

In some aspects, the systems and techniques herein dynamically produce a performance curve, or a part of the performance curve based on real-time data, which may be different based on the operating conditions of the ESP equipment and well conditions. Based on the actual/current/present dynamic conditions the performance curve, an operator of the well pumping system may make informed decisions about the operation of the well pumping system to efficiently extract materials, improve the length of the run, and improve the lifecycle of equipment within the downhole environment.

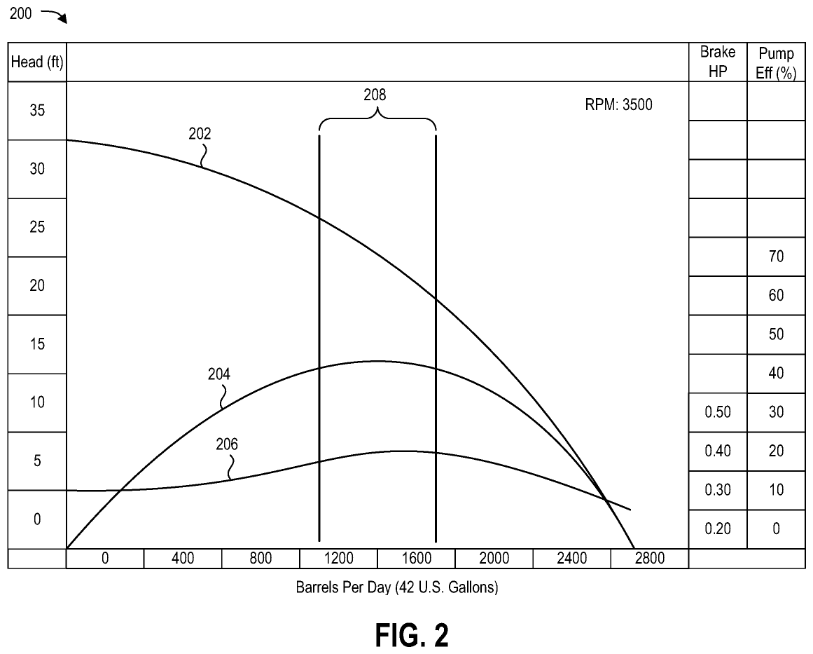

FIG. 3 illustrates a block diagram of an extraction monitoring system 300 configured to monitor correction of equipment within a downhole environment in real-time in accordance with some aspects of the disclosure. In some aspects, the extraction monitoring system 300 includes a runtime monitor 310, a client application 320, and a database 330. The runtime monitor 310 includes a measurement engine 312 that is configured to control various measurements and inferences in connection with an ML inference engine 314. The measurement engine 312 is configured to control one or more ML models of the ML inference engine 314 to perform multiple predictions for short-term and long-term trends based on real-time measurement data 340.

The real-time measurement data 340 can include various information relevant to the operations of the pumping system for a well. For example, the pumping system for a well may measure a current of a motor that is driving the ESP and the rotation speed of the ESP. In other aspects, the pumping system for a well can measure other information that affects the extraction of the material. For example, the pumping system for a well may include various temperature sensors. In one example, a temperature sensor may measure a temperature of the material being extracted, or a temperature sensor may measure a temperature of a surface within the well. (flow rate and pressure also should be included and explained, may be vibrations data too!!)

The ML inference engine 314 may include a plurality of ML models that are configured for various tasks of the pumping system for a well. Non-limiting examples of ML models of the ML inference engine 314 include a missing data model 315, an offline data model 316, an operation trend model 317, and a wear model 318. In some aspects, the missing data model 315 is configured to infer measurements when a sensor goes offline. For example, a sensor may become unavailable within a high-pressure environment and may become temporarily available. The ML inference engine 314 is configured to infer missing data from unavailable sensors using the missing data model 315. The offline data model 316 is configured to infer operations of a sensor that is not at all available during the operation. For example, some sensors can be recording data but are unable to provide that data during the operation and the offline data model 316 is configured to infer the measurements based on previous training using recorded data.

The operation trend model 317 is configured to analyze trends across all operations associated with a pumping system for a well and identify and predict long-term changes. For example, the operation trend model 317 may predict that the temperature may rise 0.1 degrees over the next hour, which can be used to assist in controlling the motor of the ESP. The operation trend model 317 is trained based on a combination of pre-existing data associated with other pumping systems for wells that are similar or different. In some cases, the operation trend model 317 is trained based on normalizing all data from previous operations based on time and other units to identify patterns with respect to a number of variations that a person cannot perform (e.g., location, surface materials, various parameters such as temperature, pressure, flow rate, density, viscosity, frequency, vibration, current, voltage, etc.).

The wear model 318 is configured to detect wear of an ESP disposed within a downhole environment. The downhole environment is a harsh environment that causes physical degradation of components of the various equipment due to the presence of corrosive and/or abrasive materials (e.g., erosion of the pump due to abrasive materials such as sand, corrosion due to chemical reactions, etc.), wax buildup and other factors. The number of factors that cause wear of the ESP is too complex for a person to calculate as some factors are difficult to understand, especially in real-time.

Pump performance and motor operating conditions are affected by wear. Generally, the performance is different than the initial testing done by the manufacturer and during the prior time period. Because of the wear, the pump performance deteriorates and motor operating conditions are also change based on the pump performance. Wear rate is the rate of change in the performance over time due to various operating conditions and factors. Wear rate caused by different operating conditions and factors that have different characteristics. For example, wear rate due to sand and resulting erosion may be different than the wear rate due to wax build up, wear rate due to corrosion may be different than erosion, etc.

In some aspects, the wear model 318 is a trained ML model that learns patterns based on inference and statistical probabilities. Non-limiting examples of machine learning techniques that incorporate statistical techniques include linear regression, logistic regression, decision trees, random forest, support vector machine (SVM), and nearest neighbors such as K-nearest neighbors (KNN). In some aspects, a training system is configured by generating a training application that implements an ML framework (also referred to as an AI framework) for training weights associated with a neural network to infer based on training data. Non-limiting examples of an ML framework include Scikit Learn, TensorFlow, Theanos, Caffe, MxNet, Keras, PyTorch, Cognitive Tooltik (CNTK), Open Neural Net (OpenNN), Google AutoML, and Thinc. Each framework has strengths, weaknesses, and varying complexity. For example, PyTorch is popular for simple training due to a simpler application programming interface (API), but not ideal for many tasks because of slow compute time due to limited graphical processor unit (GPU) and neural net processing unit (NNPU) integration.

The wear model 318 is trained by the training system based on past data that is normalized in time and is configured to infer a deterioration of the performance of the ESP based on various factors such as the well environment, operation parameters of the equipment (e.g., current supplied to the ESP, etc.) throughout the duration of the operation, and so forth. The training system is trained to infer rates at which at least one aspect (e.g., flow, pressures, speed, voltage or current etc.) of the ESP is degrading. In some cases, multiple aspects of the equipment can be estimated. In some examples, the wear model 318 may be trained to estimate the wear rate of a motor of the ESP, the wear rate of a gas separator, the wear rate of a seal to isolate well fluids, and the wear rate of a downhole gauge of the ESP.

In some aspects, a statistics engine 319 is configured to use the output from the wear model 318 and real-time operational data (e.g., various parameters such as current, flow, etc.) to estimate failure of an ESP disposed within a downhole environment. The statistics engine 319 may be configured to perform a rule-based calculation based on the current environment and a current wear rate to estimate a lifecycle of the ESP. In one aspect, the statistics engine 319 generates an estimated percentage of stage wear on the ESP disposed within the downhole environment based on the measurement data and failure data. In some aspects, the statistics engine 319 is also configured to generate confidence levels based on the data to provide guidance for decisions regarding the operation of the ESP and other equipment. Information generated by the statistics engine is output to the client application 320 and the database 330. In some cases, database 330 is used to distribute information pertaining to the operation of multiple well-pumping systems. For example, a well operator can use the information in the database 330 to analyze different well pumping systems and control operation parameters in consideration of schedules, equipment availability, and other considerations. For example, the client application 320 may be configured to identify economic information pertaining to resource extraction and allow an operator to tune the performance of one or more well-pumping systems for maximizing performance and minimizing downtime.

The client application 320 is configured to display the performance information based on short-term trends and long-term trends in real-time. The client application 320 can be any type of application, such as a web application that renders in a browser, a platform framework that uses a desktop render to render the app or a browser to render, or a hybrid framework (e.g., Xamarin, .Net MAUI, Electron, etc.) that uses a common language runtime and an embedded browser to execute the application. In some cases, the client application can be a server-rendered application.

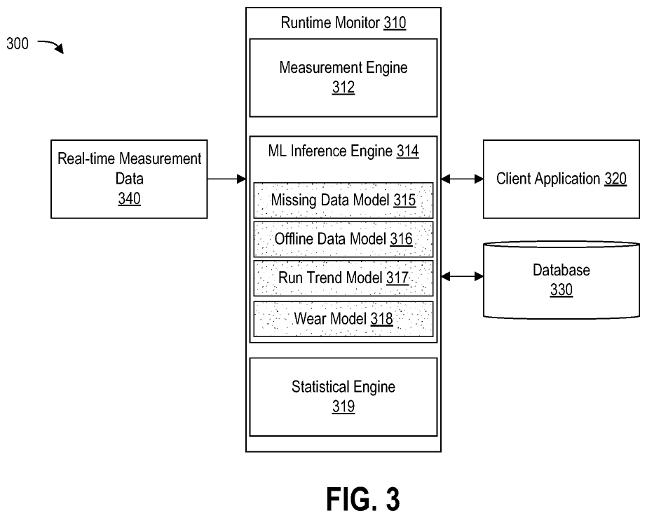

FIG. 4 is a conceptual diagram of a training system 400 of a wear model for estimating wear rates of at least one equipment disposed within a harsh environment in accordance with some aspects of the disclosure. In some aspects, the training system 400 includes a normalization engine 410, a training engine 420, and a validation engine 430.

The normalization engine 410 is configured to receive benchmark data 402, past measurement data 404, and failure data 406 and normalize the information into time-series data. In some aspects, pumps (e.g., an ESP, etc.) are tested in an environment under controlled conditions for the effect of the wear on performance. For example, performance of a pump in a controlled test environment with a test fluid, to control the measurement of performance of the pump with different properties in based on ideal conditions. The benchmark data 402 may be provided from a manufacturer of the equipment and provides a ground truth of ideal operation of the pump. Past measurement data 404 is data recorded during previous operations (e.g. data from previous runs, etc.), and failure data 406 is information that is collected as part of the rehabilitation of the equipment and may be used to identify one or more operational failures of the equipment.

In some aspects, the normalization by the normalization engine 410 maps the benchmark data 402, the past measurement data 404, and the failure data 406 into a time-series data with common set of properties. The normalized data is then provided to the training engine 420. The normalized data may also be stored as part of a training dataset.

The training engine 420 is configured to use the normalized data and train weights of an ML model using backpropagation. In some aspects, the normalized data provides information in a consistent format to the training engine 420 and assists in identifying points in time, particularly from disparate datasets having different data. For example, the failure data may identify various components of the ESP at the time of failure. The failure data can assist the training engine 420 to identify relationships that caused the failure.

The validation engine 430 is configured to validate the ML model provided by the training engine 420. For example, the validation engine 430 can compare a loss of the validation dataset to determine whether further training is needed. If the loss of the validation dataset is within a target range, the validation engine 430 is complete and the final weights are then stored as a binary file.

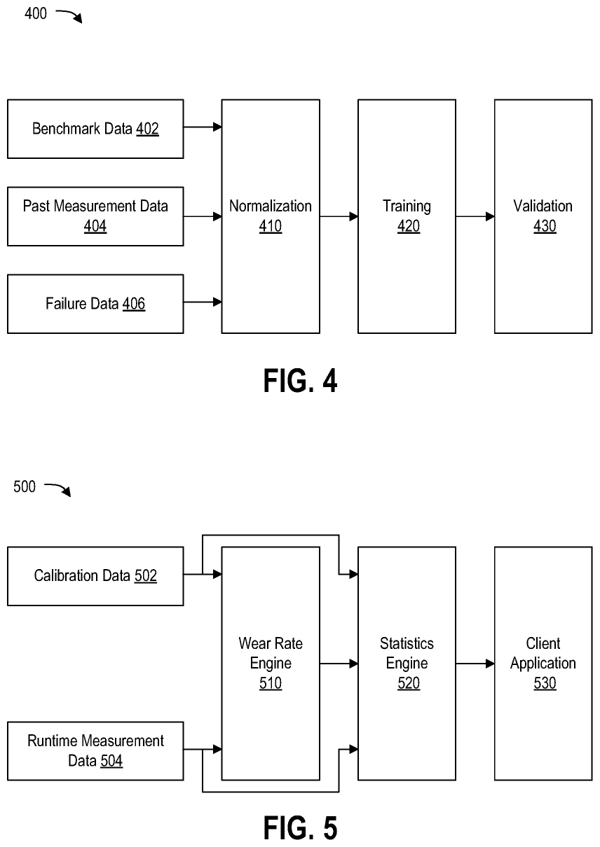

FIG. 5 is a conceptual diagram of a prediction system 500 for estimating wear rates of at least one equipment disposed within a harsh environment in accordance with some aspects of the disclosure. In some aspects, the prediction system 500 includes a wear rate engine 510, a statistics engine 520, and a client application 530 (e.g., the client application 320).

The wear rate engine 510 includes a wear model, for example, the ML model generated by the training system 400 of FIG. 4. The wear rate engine 510 also includes additional rule-based functions to preprocess calibration data 502 associated with the equipment in operation, and runtime measurement data 504 associated with the equipment (e.g., an ESP). The calibration data is measured performance of the equipment in a controlled environment. In some cases, the calibration data is measured after each maintenance of the pump (e.g., due to failure). In other cases, the calibration can be performed a single time, or based on an interval (e.g., 3 months, every 3 failures, etc.). In some cases, the calibration data 502 can also include the benchmark data. The wear rate engine also includes additional instructions to interface with the underlying system, such as providing instructions to initialize a specialized processing core (e.g., a GPU, an NNPU, etc.). The wear rate engine 510 receives the calibration data 502 and the field measurement data 504 and generates at least one wear rate associated with at least one equipment (e.g., the ESP) disposed within the downhole environment. In some aspects, the wear rate engine 510 may be configured to output multiple information related to wear rates of different components associated with the ESP. For example, the failure data 406 may identify multiple parameters that are associated with the failure and the wear rate model can be configured to identify a plurality of wear rates for the different aspects of the ESP.

The statistics engine 520 is configured to receive the wear rate from the wear rate engine 510 and perform a statistics-based calculation to identify a failure point of one or more components (e.g., a motor, etc.) of the ESP. In one non-limiting example, the failure point can be a mean time to failure (MTTF), which is provided for convenience and simplicity of explanation. In other examples, the failure point may correspond to a constructive failure at which the equipment are deemed to be operationally ineffective. For example, a constructive failure may correspond to an inflection point at which continued operation can have severe consequences and further operation is undesirable. In some aspects, the calculation may also include an MTTF or a constructive failure point for the ESP. The statistics engine may preprocess calibration data 502 and the runtime measurement data 504 in connection with the failure point calculations. A statistical model is generated based on previous failures and measurements and combines estimated wear rates into an estimate associated with the failure point. In some aspects, the statistical model may also use calibration data from the equipment in a controlled calibration environment. For example, pumps are tested in a testing environment under controlled conditions to ascertain an understanding of the effect of the wear on performance (e.g., a wear model). The statistical model is based on the wear model, as well as deviations in real-time performance as compared to a controlled environment, and other factors.

In some aspects, the statistics engine 520 may also be used to project different scenarios based on confidence levels and different variations of operation parameters input into the wear rate engine 510. For example, the statistics engine 520 may receive projected changes in operation parameters to predict extraction, performance, and failure.

The information from the statistics engine (e.g., an MTTF, a confidence level of the MTTF) and other distribution information (skewedness, standard deviation, etc.) is provided to the client application 530, to allow real-time feedback control of the ESP. In other aspects, the client application 530 can be a distributed application that enables remote monitoring, predictive operation, and informed control of well-pumping systems.

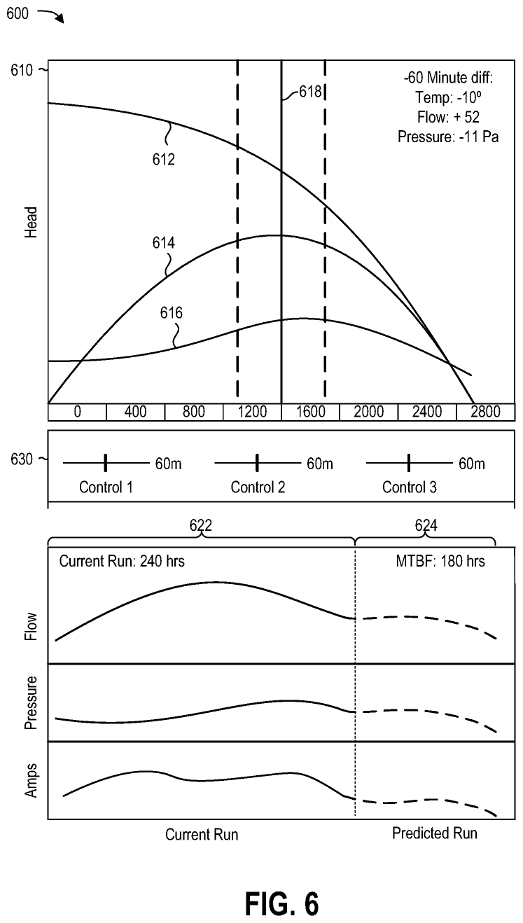

FIG. 6 is an example of a user interface 600 associated with an application for monitoring and/or controlling operations of a well-pumping system in accordance with some aspects of the disclosure. The user interface 600 includes a performance curve 610 identifying the performance of the ESP in the downhole environment based on real-time data. For example, the performance curve 610 includes the head capacity 612, the efficiency 614, and the BHP 616 of current measurement data. The performance curve 610 may also include a cursor 618 that identifies a real-time operation point.

The user interface 600 also includes a wear rate section 620 that presents information pertaining to real-time operation of a well pumping system (e.g., an ESP). In some aspects, the wear rate section 620 includes measurements associated with the current run 622. The wear rate section 620 includes forecasted measurements associated with a predicted portion of the run. The portions are illustrated for exemplary purposes only and are not to scale. In this case, the MTTF and a confidence level of the MTTF is displayed. Other aspects can also be predicted based on the wear model, such as the current consumption.

The user interface 600 also includes a control section 630 for controlling current and/or future performance. For example, the control section can be configured for projecting changes in operation to control the prediction region of the well pumping system. As noted above, the wear model can generate predictive wear rates based on projected changes, and the predicted wear rates can then be fed into the application, for example, displaying the user interface 600. In this case, an operator can configure the operation parameters to prolong the duration of the run while optimizing extraction of resources from the downhole environment. As a result, a well operator can prolong the duration of the run, or can preliminarily end the duration of a run to optimize utilization of resources associated with rehabilitating a well pumping system after ending a run.

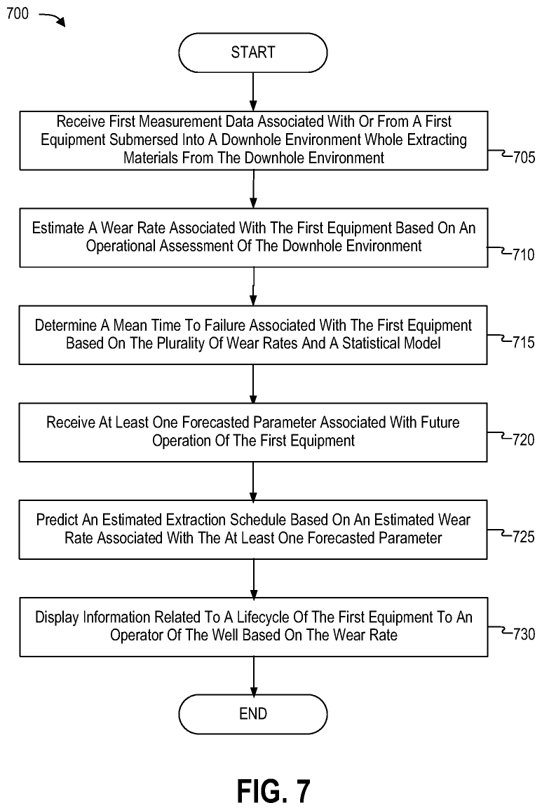

FIG. 7 illustrates an example method 700 for determining a wear rate of equipment disposed within a downhole environment in accordance with some aspects of the disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

At block 705, the computing system may receive first measurement data associated with or from a first equipment submersed into a downhole environment during a portion of a current operation for extracting materials from the downhole environment at a pumping system; and

At block 710, the computing system may estimate a wear rate associated with the first equipment based on an operational assessment of the downhole environment. In some aspects, the wear rate of an equipment (e.g., an ESP) and/or components of the ESP may be determined by an ML model. The ML model may be trained based on measurement data, (past historical) data (e.g., data from a manufacturer regarding the wear rates), and failure data. As described above, the data can be normalized and improve training of the ML model. In some aspects, the ML model may use previous operational data associated with the first equipment to generate inferences. In some aspects, the wear rate comprises a plurality of wear rates associated with the first equipment. In this case, the machine learning model is configured to generate the wear rate based at least in part of the first measurement data.

At block 715, the computing system may determine a MTTF associated with the first equipment based on the plurality of wear rates and a statistical model.

At block 720, the computing system may receive at least one forecasted parameter associated with future operation of the first equipment. For example, an operator can provide input to see projected performance based on changing an operation parameter (e.g., current, etc.). In some aspects, the estimated extraction schedule identifies an estimated failure date of the first equipment. The estimated extraction schedule may also include a confidence level of the estimated extraction schedule.

At block 725, the computing system may predict an estimated extraction schedule based on an estimated wear rate associated with the at least one forecasted parameter. For example, an operator may choose to accelerate extraction of the resources due to a schedule.

At block 730, the computing system may display information related to a lifecycle of the first equipment to an operator of the well based on the wear rate. For example, the MTTF of the ESP may be projected along with a confidence level. For example, the computing system may display a performance curve corresponding to real-time predictions of the first equipment and, in response to an input related to a change in the performance curve, map the input to modify the performance curve. The computing system may also display a predicted material extraction schedule based on the input to modify the performance curve.

In some cases, the computing system may also supplement training of a machine learning model (e.g., federated learning) based on additional data and other information provided during the operation.

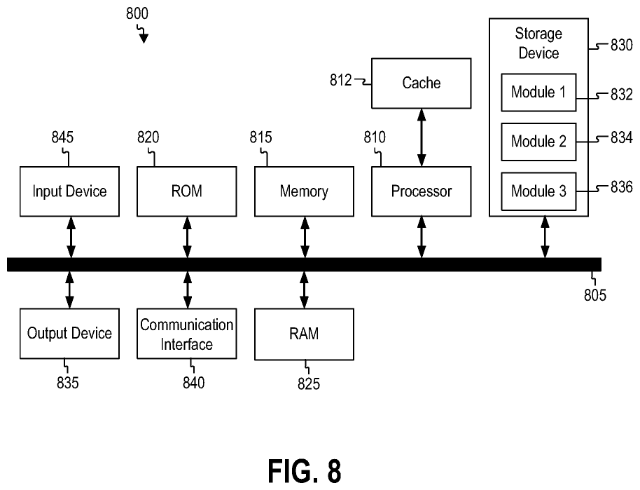

FIG. 8 is a diagram illustrating an example of a system for implementing certain aspects of the present technology. In particular, FIG. 8 illustrates an example of computing system 800, which may be for example any computing device making up an internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 800 includes at least one processing unit (CPU or processor) 810 and connection 805 that couples various system components including system memory 815, such as ROM 820 and RAM 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical, electrical signal input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800. Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device may be implemented in circuitry. For example, the components may include and/or may be implemented using electronic circuits or other electronic hardware, which may include one or more programmable electronic circuits (e.g., microprocessors, GPUs, DSPs, CPUs, and/or other suitable electronic circuits), and/or may include and/or be implemented using computer software, firmware, or any combination thereof, to perform the various operations described herein.

In some aspects the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures may include hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of detecting wear rate of the equipment at a pumping system for a well, comprising: receiving first measurement data associated with or from a first equipment submersed into a downhole environment during a portion of a current operation for extracting materials from the downhole environment at a pumping system; and estimating a wear rate associated with the first equipment based on an operational assessment of the downhole environment.

Aspect 2. The method of Aspect 1, wherein estimating the wear rate comprises analyzing previous operational data associated with the first equipment.

Aspect 3. The method of any of Aspects 1 to 2, wherein the wear rate comprises a plurality of wear rates associated with the first equipment, and wherein a machine learning model is configured to generate the wear rate based at least in part of the first measurement data.

Aspect 4. The method of any of Aspects 1 to 3, further comprising: receiving at least one forecasted parameter associated with future operation of the first equipment; and predicting an estimated extraction schedule based on an estimated wear rate associated with the at least one forecasted parameter.

Aspect 5. The method of any of Aspects 1 to 4, wherein the estimated extraction schedule identifies an estimated failure date of the first equipment.

Aspect 6. The method of any of Aspects 1 to 5, wherein the estimated extraction schedule includes a confidence level of the estimated extraction schedule.

Aspect 7. The method of any of Aspects 1 to 6, further comprising: computing a mean time to failure associated with the first equipment based on the plurality of wear rates and a statistical model.

Aspect 8. The method of any of Aspects 1 to 7, further comprising: displaying information related to a lifecycle of the first equipment to an operator of the well based on the wear rate.

Aspect 9. The method of any of Aspects 1 to 8, further comprising: displaying a performance curve corresponding to real-time predictions of the first equipment; and in response to an input related to a change in the performance curve, mapping the input to modify the performance curve.

Aspect 10. The method of any of Aspects 1 to 9, further comprising: displaying a predicted material extraction schedule based on the input to modify the performance curve.

Aspect 11. A system for detecting equipment wear at a pumping system includes a storage (implemented in circuitry) configured to store instructions and a processor. The processor is configured to execute the instructions and cause the processor to: receive first measurement data associated with or from a first equipment submersed into a downhole environment during a portion of a current operation for extracting materials from the downhole environment at a pumping system; and estimate a wear rate associated with the first equipment based on an operational assessment of the downhole environment.

Aspect 12. The system of Aspect 11, wherein estimating the wear rate comprises analyzing previous operational data associated with the first equipment.

Aspect 13. The system of any of Aspects 11 to 12, wherein the wear rate comprises a plurality of wear rates associated with the first equipment, and wherein a machine learning model is configured to generate the wear rate based at least in part of the first measurement data.

Aspect 14. The system of any of Aspects 11 to 13, wherein the processor is configured to execute the instructions and cause the processor to: receive at least one forecasted parameter associated with future operation of the first equipment; and predict an estimated extraction schedule based on an estimated wear rate associated with the at least one forecasted parameter.

Aspect 15. The system of any of Aspects 11 to 14, wherein the estimated extraction schedule identifies an estimated failure date of the first equipment.

Aspect 16. The system of any of Aspects 11 to 15, wherein the estimated extraction schedule includes a confidence level of the estimated extraction schedule.

Aspect 17. The system of any of Aspects 11 to 16, wherein the processor is configured to execute the instructions and cause the processor to: compute a mean time to failure associated with the first equipment based on the plurality of wear rates and a statistical model.

Aspect 18. The system of any of Aspects 11 to 17, wherein the processor is configured to execute the instructions and cause the processor to: display information related to a lifecycle of the first equipment to an operator of the well based on the wear rate.

Aspect 19. The system of any of Aspects 11 to 18, wherein the processor is configured to execute the instructions and cause the processor to: display a performance curve corresponding to real-time predictions of the first equipment; and in response to an input related to a change in the performance curve, map the input to modify the performance curve.

Aspect 20. The system of any of Aspects 11 to 19, wherein the processor is configured to execute the instructions and cause the processor to: display a predicted material extraction schedule based on the input to modify the performance curve.

Aspect 21. A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: receive first measurement data associated with or from a first equipment submersed into a downhole environment during a portion of a current operation for extracting materials from the downhole environment at a pumping system; and estimate a wear rate associated with the first equipment based on an operational assessment of the downhole environment.

Aspect 22. The computer readable medium of Aspect 21, wherein estimating the wear rate comprises analyzing previous operational data associated with the first equipment.

Aspect 23. The computer readable medium of any of Aspects 21 to 22, wherein the wear rate comprises a plurality of wear rates associated with the first equipment, and wherein a machine learning model is configured to generate the wear rate based at least in part of the first measurement data.

Aspect 24. The computer readable medium of any of Aspects 21 to 23, wherein the processor is configured to execute the computer readable medium and cause the processor to: receive at least one forecasted parameter associated with future operation of the first equipment; and predict an estimated extraction schedule based on an estimated wear rate associated with the at least one forecasted parameter.

Aspect 25. The computer readable medium of any of Aspects 21 to 24, wherein the estimated extraction schedule identifies an estimated failure date of the first equipment.

Aspect 26. The computer readable medium of any of Aspects 21 to 25, wherein the estimated extraction schedule includes a confidence level of the estimated extraction schedule.

Aspect 27. The computer readable medium of any of Aspects 21 to 26, wherein the processor is configured to execute the computer readable medium and cause the processor to: compute a mean time to failure associated with the first equipment based on the plurality of wear rates and a statistical model.

Aspect 28. The computer readable medium of any of Aspects 21 to 27, wherein the processor is configured to execute the computer readable medium and cause the processor to: display information related to a lifecycle of the first equipment to an operator of the well based on the wear rate.

Aspect 29. The computer readable medium of any of Aspects 21 to 28, wherein the processor is configured to execute the computer readable medium and cause the processor to: display a performance curve corresponding to real-time predictions of the first equipment; and in response to an input related to a change in the performance curve, map the input to modify the performance curve.

Aspect 30. The computer readable medium of any of Aspects 21 to 29, wherein the processor is configured to execute the computer readable medium and cause the processor to: display a predicted material extraction schedule based on the input to modify the performance curve.

What is claimed is:

1. A method of detecting wear rate of the equipment at a pumping system for a well, comprising:
receiving first measurement data associated with or from a first equipment submersed into a downhole environment during a portion of a current operation for extracting materials from the downhole environment at a pumping system; and
estimating a wear rate associated with the first equipment based on an operational assessment of the downhole environment.

2. The method of claim 1, wherein estimating the wear rate comprises analyzing previous operational data associated with the first equipment.

3. The method of claim 1, wherein the wear rate comprises a plurality of wear rates associated with the first equipment, and wherein a machine learning model is configured to generate the wear rate based at least in part on the first measurement data.

4. The method of claim 3, further comprising:
receiving at least one forecasted parameter associated with future operation of the first equipment; and
predicting an estimated extraction schedule based on an estimated wear rate associated with the at least one forecasted parameter.

5. The method of claim 4, wherein the estimated extraction schedule identifies an estimated failure date of the first equipment.

6. The method of claim 4, wherein the estimated extraction schedule includes a confidence level of the estimated extraction schedule.

7. The method of claim 3, further comprising:
determine a mean time to failure associated with the first equipment based on the plurality of wear rates and a statistical model.

8. The method of claim 1, further comprising:
displaying information related to a lifecycle of the first equipment to an operator of the well based on the wear rate.

9. The method of claim 8, further comprising:
displaying a performance curve corresponding to real-time predictions of the first equipment; and
in response to an input related to a change in the performance curve, mapping the input to modify the performance curve.

10. The method of claim 9, further comprising: displaying a predicted material extraction schedule based on the input to modify the performance curve.

11. A system for detecting equipment wear at a pumping system, comprising:
a storage configured to store instructions; and
a processor configured to execute the instructions and cause the processor to:
receive first measurement data associated with or from a first equipment submersed into a downhole environment during a portion of a current operation for extracting materials from the downhole environment at a pumping system; and
estimate a wear rate associated with the first equipment based on an operational assessment of the downhole environment.

12. The system of claim 11, wherein estimating the wear rate comprises analyzing previous operational data associated with the first equipment.

13. The system of claim 11, wherein the wear rate comprises a plurality of wear rates associated with the first equipment, and wherein a machine learning model is configured to generate the wear rate based at least in part of the first measurement data.

14. The system of claim 13, wherein the processor is configured to execute the instructions and cause the processor to:
receive at least one forecasted parameter associated with future operation of the first equipment; and
predict an estimated extraction schedule based on an estimated wear rate associated with the at least one forecasted parameter.

15. The system of claim 14, wherein the estimated extraction schedule identifies an estimated failure date of the first equipment.

16. The system of claim 14, wherein the estimated extraction schedule includes a confidence level of the estimated extraction schedule.

17. The system of claim 13, wherein the processor is configured to execute the instructions and cause the processor to:
determine a mean time to failure associated with the first equipment based on the plurality of wear rates and a statistical model.

18. The system of claim 11, wherein the processor is configured to execute the instructions and cause the processor to:
display information related to a lifecycle of the first equipment to an operator of the well based on the wear rate.

19. The system of claim 18, wherein the processor is configured to execute the instructions and cause the processor to:
display a performance curve corresponding to real-time predictions of the first equipment; and
in response to an input related to a change in the performance curve, map the input to modify the performance curve.

20. The system of claim 19, wherein the processor is configured to execute the instructions and cause the processor to: display a predicted material extraction schedule based on the input to modify the performance curve.
